(19) United States
(12) Patent Application Publication
(10) Pub. No.: US 2025/0020805 A1
(43) Pub. Date: Jan. 16, 2025

(54) METHOD AND APPARATUS FOR GENERATION OF POLYNOMIAL DELAY VALUES

(71) Applicant: DarkVision Technologies Inc., North Vancouver (CA)

(72) Inventor: Graham T. Manders, North Vancouver (CA)

(21) Appl. No.: 18/715,758

(22) PCT Filed: Jun. 2, 2023
(86) PCT No.: PCT/IB2023/055686

§ 371 Date: Jun. 3, 2024

Related U.S. Application Data
(60) Provisional application No. 63/349,593, filed on Jun. 7, 2022.

(51) Int. Cl. G01S 15/89; G01S 7/521

(52) U.S. Cl. CPC G01S 15/89; G01S 7/521

(57) ABSTRACT

Various embodiments of a method and apparatus for performing delay calculations are disclosed. In some embodiments, the delay values are used for nondestructive ultrasound imaging. The delay calculations are performed by interpolating the delay values between sampled delay values. In some embodiments, an interpolation polynomial is evaluated for each position in an interpolation region of a transducer array. In some embodiments, the delay values are computed by interpolating the polynomial coefficients. In some embodiments, higher order derivatives of the delay are integrated to compute lower order derivatives, where the derivatives are computed based on the polynomial coefficients. The process is continued until the delay function computes from the first derivatives of the delay function. The delay function is then derived by integrating the first derivative of the delay function.

### RELATED APPLICATIONS

This application claims priority to U.S. Patent Application No. 63/349,593 filed on Jun. 7, 2022, which is incorporated herein by reference in its entirety.

### TECHNICAL FIELD

The disclosed method and apparatus relate generally to systems for imaging. In particular, the disclosed method and apparatus relate to a nondestructive ultrasound imaging system.

### BACKGROUND

When imaging a “target region”, including objects within the target region, signals are generated and transmitted towards the target region. In some cases, these signals may be ultrasound pulses. The reflections of the signals are then detected. Signals reflected by closer portions of the target region arrive at the detector sooner. Also, different wavelengths may travel at different speeds, especially when traveling through mediums of different density. Consequently, to create an image, the delay of each signal may be computed to facilitate combining the detected signals into a coherent image. In some cases, a two-dimensional array of transducer elements is used for the imaging. Accordingly, transducer elements of the array are arranged in rows and columns. A “delay profile” is a map of the relative delays of signals transmitted from different transducer elements. The delay profile can be defined to focus (i.e., “form”) a transmit beam. The delay profile defines a three dimensional surface with the x and y dimensions being the location of each transducer element in the row and column of the array 102 respectively, and the z dimension being the amount of relative delay to be applied before the transducer element transmits a signal with respect to time other transducer elements in the array transmit. In some cases, the transducer elements may be addressed row-by-row. However, addressing all the array's transducer elements row-by-row is different from addressing all the rows together. During ultrasound imaging, individually addressing each row is equivalent to having overlapped linear arrays of piezoelectric transducer elements. However, using linear arrays that overlap one another does not provide an image of a target with the same quality as can be attained using a two-dimensional array.

When imaging a target region using a two-dimensional transducer array, it is helpful to place the addressing circuitry close to the transducer array. However, placing the addressing circuitry close to the transducer array limits the space available for circuitry.

Also, loading the transmit delays takes a large amount of resources/time and may require many high-speed interfaces. For example, in a system having a transducer array with 4K transducer elements, 4096 delays need to be computed. If it is desirable to compute all delays in less than 10 μs and each delay requires 10 to 16 bits to be computed, the required bit rate for 4096 delays, where each bit takes 1×10⁻⁶ s, the bit rate=(16 bits/delay) (delay/10e−6 s)=6.5 Gbit/s. A bit rate of 6.5 Gbit/s would require up to 32 Low-Voltage Differential Signaling (LVDS) pairs running at 200 Mbit/s. Running that many LVDS pairs at 200 Mbits/s is burdensome and requires a lot of Input/Output (I/O) resources, processor resources, and Field Programmable Gate Array (FPGA) resources. Accordingly, running that many LVDS at that bit rate requires a lot of power to drive the I/O.

Therefore, it would be advantageous to provide a more efficient system to estimate the delay profile.

### SUMMARY

Various embodiments of a method and apparatus for computing a delay profile used in forming a beam for imaging a target region are disclosed. The delay profile provides delays for each of the elements of an imaging array that generates and transmits a signal into a target region. Some of the disclosed embodiments compute the delay profile for a two-dimensional imaging array. In some embodiments, the imaging array is an ultrasound transducer array. In some such embodiments, the ultrasound transducer array is an array of piezoelectric transducer elements. The images generated through the use of the disclosed embodiments are used in several ways. One such use is in nondestructive testing.

Five different approaches are disclosed for determining the delay profile to be applied to the imaging array and for applying that delay profile to the transducer array. In each approach, the transducer array is collocated on a common die with a pulser subsystem and a delay decompression subsystem (DDS). A resource external to the die provides a compressed delay profile to the die using a compression technique. In some embodiments, several dies are included within an integrated circuit. Each such die is coupled to a common external resource that provides information from which each such die can determine an appropriate delay profile to be applied to the transducer array.

In the first approach, the compression technique that is used complies with the industry standard, such as JPEG2000. Compression by such a technique allows for convenient resizing and 12-bit depth by the DDS within the die upon receipt of the compressed delay profile. Consequently, compression by a such a technique provides a reasonable approach to allow a delay profile to be computed by a resource external to the die, while reducing the amount of data needed to be provided to the die to project a desired signal into a target region.

In the second approach, the DDS within the die performs linear interpolation of a low resolution delay profile generated by a resource external to the die and communicated to the die. The use of a low resolution delay profile reduces the amount of data needed to be communicated from the external resource to the die.

In the third approach, a low resolution delay profile is provided to the die by a resource external to the die, similar to the first and second approach. However, the DDS performs bicubic (or biquadratic) interpolation of a low resolution delay profile to generate each of the delays for each of the elements of the transducer array.

In the fourth approach, rather than sending a low resolution delay profile, bicubic coefficients are calculated by a resource external for the desired delay profile. These calculated bicubic coefficients are then sent to the die from the external resource. The delay values for the desired delay profile are then determined based on the bicubic coefficients.

In the fifth approach, a combination of the second and third approach is performed (i.e., a combination of bicubic and linear interpolation performed on the die on a low resolution delay profile provided by a source external to the die).

In some embodiments in which a low resolution delay profile is provided to the die by the external resource in accordance with the third approach noted above, the composition of the low resolution delay profile is determined based on desired delays for a finite number of transducer elements. In some such embodiments, the finite number of transducer elements for which delays are included in the low resolution delay profile is smaller than the total number of transducer elements in an interpolation region (thus the justification for referring to the delay profile as being “low resolution”). The interpolation region is a portion of the transducer array for which values can be computed from an interpolation polynomial. The interpolation region may include all of the transducer elements provided on the array of a die, the transducer elements of the arrays of several dies within a single integrated circuit, a small portion of the transducer elements that reside within the arrays of several different dies, or a portion of the array of just one die. The delay values of the other transducer elements of the interpolation region are interpolated by calculating the bicubic interpolation coefficients and using these coefficients to determine the delays to be applied to the other transducer elements. In some embodiments, the low-resolution delay profile includes 16 delay values for a select 16 transducer elements within an interpolation region. The 16 values equal the number of coefficients of the bicubic interpolation polynomial. Accordingly, having the 16 delay values allows the 16 unknown bicubic interpolation coefficients to be determined.

In some embodiments that use the fourth approach, polynomial coefficients are derived by a resource external to the die from the known values of the delay that result in a desired transmission “waveform”. In the case in which the shape of the wave to be transmitted by the transducer elements of the array is known, the delay values associated with each element relative to each other element can be calculated. In some embodiments, this is done in a processor external to an ASIC having the transducer array. In some embodiments, a full delay profile is determined by the DDS using bicubic interpolation by applying the bicubic interpolation coefficients provided by the external resource to the bicubic polynomial. In other embodiments, other polynomials or functions are used.

In some embodiments, instead of evaluating the interpolation polynomial at each transducer element, the delay function is evaluated by integrating higher order derivatives to obtain lower order derivatives. The derivatives are integrated based on prior values of the delay function and the derivatives polynomial at neighboring transducer elements. Eventually, the first-order derivatives are determined by the integration. The value of the delays at the transducer elements of interest are computed by integrating the first-order derivatives. In other embodiments, other methods of approximating the interpolation polynomial or interpolating the polynomial coefficients.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1A is a simplified schematic of a system that computes a compressed delay profile.

FIG. 1B is a simplified schematic of the die within the system of FIG. 1A.

FIG. 3 illustrates a flowchart of some embodiments of a method of implementing the compressed delay profile.

FIG. 4 is an illustration representing the locations of transducer elements in a transducer array.

FIG. 5 illustrates an example of two apertures for computing the delay profile.

FIG. 6A illustrates an example of an initial delay profile.

FIG. 6B illustrates the error in the delay profile computed by the method of FIG. 3.

FIG. 6C illustrates the relative error in the delay profile computed by the method of FIG. 3.

FIG. 7A illustrates another example of an initial delay profile.

FIG. 7B illustrates the error in the delay profile computed by the method of FIG. 3.

FIG. 7C illustrates the relative error in the delay profile computed by the method of FIG. 3.

FIG. 8A illustrates another example of an initial delay profile.

FIG. 8B illustrates the error in the delay profile computed by the method of FIG. 3.

FIG. 8C illustrates the relative error in the delay profile computed by the method of FIG. 3.

FIG. 9A illustrates another example of an initial delay profile.

FIG. 9B illustrates the error in the delay profile computed by the method of FIG. 3.

FIG. 9C illustrates the relative error in the delay profile computed by the method of FIG. 3.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION OF THE PREFERRED EMBODIMENTS

### Overview

The present disclosure provides a method and apparatus for efficiently communicating information from which the appropriate amount of delay to apply to each transducer element of a transducer array can be determined and used to image a target region and/or objects present within the target region. Initially, the hardware used to perform the imaging is disclosed to provide context for the delay compression/decompression method and apparatus that is disclosed after the initial introduction to the system hardware.

### Hardware System

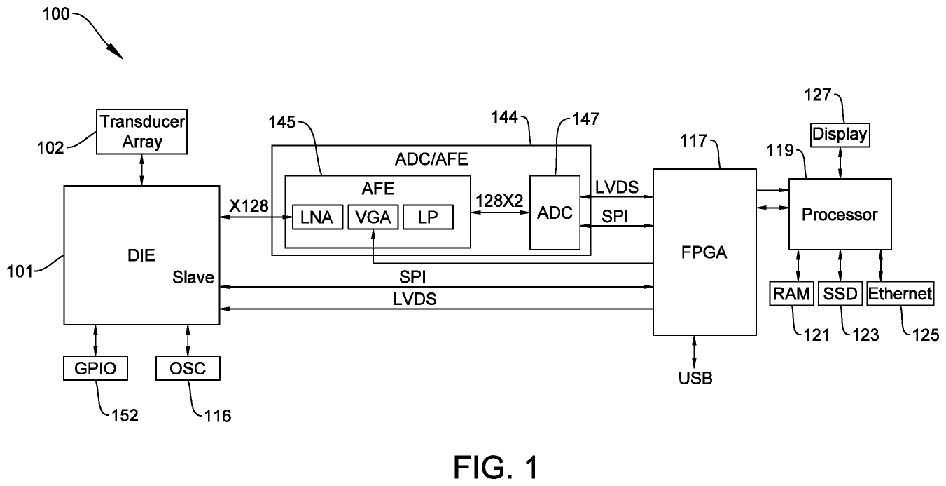

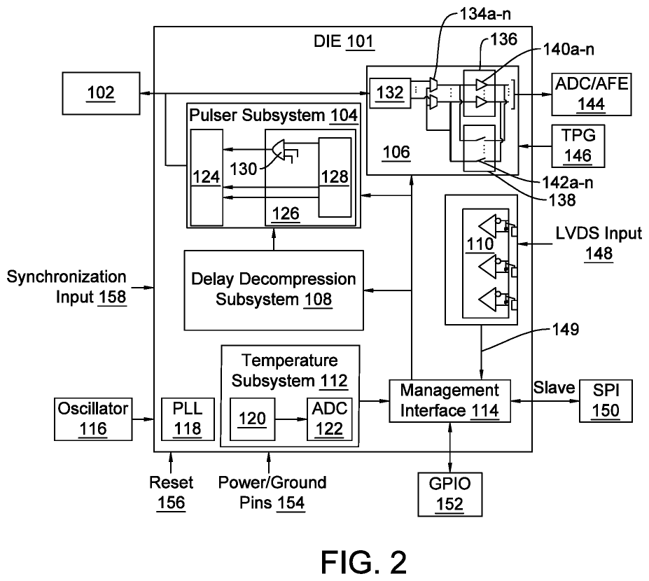

FIG. 1A illustrates an embodiment of an imaging system 100. In some embodiments, the imaging system 100 includes a transducer array 102, an oscillator 116, an Analog to Digital Converter/Audio Front End (ADC/AFE) 144, a plurality of dies 101 (only one shown for the sake of simplicity), a general purpose input/output (GPIO) port 152 to the die 101, a field programmable array (FPGA) 117, a processor 119, random access memory (RAM) 121, a solid state drive (SSD) 123, an Ethernet port 125 and a display 127. The ADC/AFE 144 comprises an ADC 147 and an AFE 145. The AFE 145 includes a low noise amplifier (LNA), a variable gain amplifier (VGA) and a low pass filter (LP). Integrated circuit chips having the die 101 may be incorporated into products produced by Original Equipment Manufacturer (OEM) integrators. In some embodiments, the die 101 allows imaging through multiple materials (such as a wedge, interface plate, or water) and allows for imaging in materials ranging from water to steel.

Some embodiments of the presently disclosed system 100 use the transducer array 102 to transmit an acoustic wave into an target region, receive a reflection back and create an image based on the reflected signal. The transducer array 102 converts received signals to a format that can be analyzed (e.g., converts acoustic signals to electrical signals). In some embodiments in which ultrasound pulses are transmitted, the transducer array 102 comprises a two-dimensional 64×64 element array of piezoelectric transducer elements arranged in rows and columns. In some embodiments the elements are lead zirconate titanate Pb[ZrxTi1-x]O3 (0≤x≤1). In other embodiments, various other materials may be used.

In some embodiments of the presently disclosed method and apparatus, a delay profile is generated that determines the shape of the waveform that is transmitted by the composite of the transmitting elements of the transducer array 102. As used in this disclosure, a “waveform” is the acoustic wave generated by exciting one or more of the transducer elements. It will be understood by those skilled in the art that other types of waveforms may also be transmitted, and the disclosed methods and apparatus are applicable to such waveforms as well.

In some embodiments, a single pulse is applied to each transducer to form the waveform. In other cases, a series of pulses are applied to one or more of the transducer elements in rapid succession. Exciting the transducer elements with a single pulse creates a sharper image. However, using a series of pulses transmitted by each of the transducer elements reduces the signal to noise ratio in the final image. The delay profile defines a three dimensional surface of a waveform to be transmitted with the x and y dimensions being the location of each transducer element in the row and column of the array 102 respectively, and the z dimension being the amount of relative delay to be applied before the transducer element transmits a signal with respect to time other transducer elements in the array transmit. Throughout this disclosure, reference is made to “the delay of a transducer element at a location” or a “transducer element delay”. These references are to the relative amount of delay to be applied when transmitting from a particular transducer element located at a location relative to other transducer elements that are transmitting other components of the same waveform.

In some embodiments, a user indicates to the processor 119, parameters related to the manner in which the image is to be taken, such as the shape of the waveform to be transmitted into a target region and number of angles of each such transmission. Alternatively, the user may specify a less detailed plan for imaging a particular object or target region, in which case, specifics about the shape of the waveform and other specifics, such as the number of angles, etc., are determined automatically by the processor 119.

In some embodiments, once the processor 119 selects a particular waveform and/or set of waveforms to be transmitted into the target region, the processor 119 conveys parameters to the FPGA 117 that can be used to generate/program a delay profile that controls when each transducer element of the transducer array 102 will be excited. The FPGA 117 uses that information to “stage” the set of waveforms to be transmitted. That is, the FPGA 117 uses the information that the processor 119 provides to determine how many times the transducer array 102 will transmit a waveform, which elements of the transducer array 102 are to be excited for each such transmission. As part of that process, the FPGA 117 also coordinates the timing between the various dies 101, each of which is responsible for controlling the excitation of a subset of the total transducer array 102.

The FPGA 117 provides both timing information to each die 101 based on the information provided by the processor 119 to the FPGA 117 to allow each die 101 to determine when to transmit waveforms and information to allow each die 101 to establish a delay profile to be applied to those elements of the transducer array 102 associated with each particular die 101 when transmitting each such waveform.

FIG. 1B illustrates details of one die 101. Each die 101 comprises a pulser subsystem 104, a receive switch subsystem 106, a DDS 108, a Low-Voltage Differential Signaling (LVDS) subsystem 110, Serial Peripheral Interface (SPI) slave device 111, a temperature subsystem 112, a management interface 114 and an optional Phase Lock Loop (PLL) 118. The principal function of the set of dies 101 is to cause the transducer array 102 to generate pulses and to capture the responsive reflections of those pulses. The resulting captured data is then provided to the processor 119 through the FPGA 117. It will be understood that in some embodiments there are several dies 101, and that each is controlled by the FPGA 117 based on information provided to the FPGA 117 by the processor 119. Each such die 101 operates essentially the same. Therefore, only one such die is explained in detail for the sake of clarity and brevity. Although in the embodiment illustrated in FIGS. 1A and 1B, the AFE 145, ADC 147, FPGA 117, and processor 119 are not located on the die 101, in some embodiments, any of the AFE 145, ADC 147, FPGA 117, and processor 119 may be located on the die 101 or on an integrated circuit chip that includes multiple dies 101.

The die 101 receives power and is connected to ground by power/ground pins 154. The die 101 can be reset by reset pins 156. A synchronization signal 158 is used to synchronize the die 101 with other dies. The temperature subsystem 112 determines the temperature of the die 101. The temperature subsystem 112 generates a signal that can then be used for temperature compensation to reduce the effects of the temperature distortion. Each die 101 is associated with and controls the operation of one section of the transducer array. In some embodiments in which the transducer array has 64×64 transducer elements (i.e., 64 rows and 64 columns), 4 dies 101 are provided, each is responsible for 32×32 of the elements of the array. In some embodiments, the transducer array 102, the LVDS subsystem 110, and the oscillator 116 are always powered on. In contrast, the pulser subsystem 104, the receive switch subsystem 106, the DDS 108, and the temperature subsystem 112 may be turned off to save power when those components are not needed.

### Waveform Transmission

For each waveform that is transmitted into the target region by the transducer array 102, the DDS 108 will receive a set of parameters from the FPGA 117. In some embodiments, for each waveform that is transmitted, information is received by all of the transducer elements of the array 102. However, only a subset of the transducer elements will provide information back to the FPGA 117 and processor 119 for any one waveform that has been transmitted. This is discussed in more detail in the Waveform Reception section below. Nonetheless, in some instances it will be desirable to receive information from a number of transducer elements that is several times the number of transducer elements in the transmitting subset. Accordingly, the same waveform will be transmitted several times. Each time, a different subset of transducer elements will be used to detect the reflected signal. The pulser subsystem 104 includes an analog pulser 124 and digital pulser 126. The digital pulser 126 includes a pulser control 128 and a digital pulse driver 130. The pulser control 128 and the digital pulse driver 130 work together to activate the analog pulser 124. Inputs to the pulse subsystem include information provided by the DDS. The analog pulser provides 1024 independent outputs, each coupled to one of the transducer elements of the array 102. The signals output from the analog pulser 124 are pulses that activate each transducer element to transmit an acoustic signal.

### Waveform Reception

After transmitting signals into the target region, the transducer elements are used to capture the reflections. Each subset of the 1024 transducer elements (e.g., the 32×32 two-dimensional subset associated with one die 101) is coupled to the inputs of the receive switch subsystem 106 of the associated die 101. The receive switch subsystem 106 includes a receive switch 132, a 1024 input to 64 output multiplexer 134, a receive buffer 136, and a buffer bypass 138. The receive buffer 136 includes buffers 140a-n, and the buffer bypass 138 includes switches 142a-n. Each transducer element is coupled to a corresponding one of 1024 inputs of the multiplexer via the receive switch 132. The multiplexer 134 sends a subset of the signals from the receive switch 132 for further processing. In some embodiments, the multiplexer 134 is capable of sending a test pattern signal rather than actual received signals. The buffers 140a-n store the signals output from the multiplexer 134 and provide them to the ADC/AFE 144 when the ADC/AFE 144 is ready. The switches 142a-n, when closed, allow the signal to bypass the buffers 140a-n and flow directly to the ADC/AFE 144.

The electrical signals provided to the ADC/AFE 144 are digitized, amplified and filtered. The output of the ADC/AFE 144 is then communicated to the FPGA 117. It should be noted that in some embodiments, the receive switch subsystem 106 receives data on the same line on which the pulser subsystem 104 drives the transducer array 102. The received data is processed by the receive switch subsystem 106 and provided to the ADC/AFE 144 to be further processed by the FPGA 117 and the processor 119.

Although in the embodiment of FIG. 1A and 1B, the FPGA 117 and the ADC 147 are located off-chip (off the die 101), in other embodiments, the FPGA 117 and the ADC/AFE 144 are located on the same chip as the die 101 or on the die 101.

In some embodiments, the pulser subsystem 104 is controlled by the management interface 114. In some embodiments, the management interface 114 is a processor or FPGA. In some embodiments, the management interface 114 is configured and controlled by either the SPI slave device 111 or the LVDS subsystem 110.

In some embodiments, configuration data provided through the SPI slave device 111 or LVDS subsystem 110 may specify information characterizing the apertures to use or other information about the beam that the transducer array 102 should generate. The DDS 108 generates a delay profile that is used to control the timing of the analog pulser 124 to produce an analog signal for driving the transducer array 102. Each transducer element of the transducer array 102 may be addressed individually when transmitting pulses. The delay profile determines the relative time at which a pulse will be generated by each transducer element of the transducer array 102 relative to each another element. In some embodiments, in addition to focusing the beam, the delay profile compensates for irregularities of the target region. For example, the delay profile may take into account a wedge shape when imaging a wedge. When imaging through multiple materials, the delay profile may compensate for the change in the index of refraction in passing through one or more layers to bring the beam to a focus on an underlying surface.

The DDS 108 determines the delay profile based on parameters provided by the FPGA 117. In some embodiments, the received data is stored in registers (not shown) that may be located anywhere on the die 101. For example, the registers may be located in the DDS 108, the management interface 114, the DDS 108, LVDS subsystem 110, in a separate location on the die 101 or elsewhere. The registers are selected based on the address provided by the LVDS subsystem 110. In some embodiments, the registers into which data can be stored include registers for: (1) chip identification data, (2) chip configuration data, (3) transmit aperture configuration data, (4) receive buffer control data, (5) DDS configuration data, (6) delay profile configuration data, (7) receiver aperture configuration data, (8) GPIO port data, and (9) sensor data.

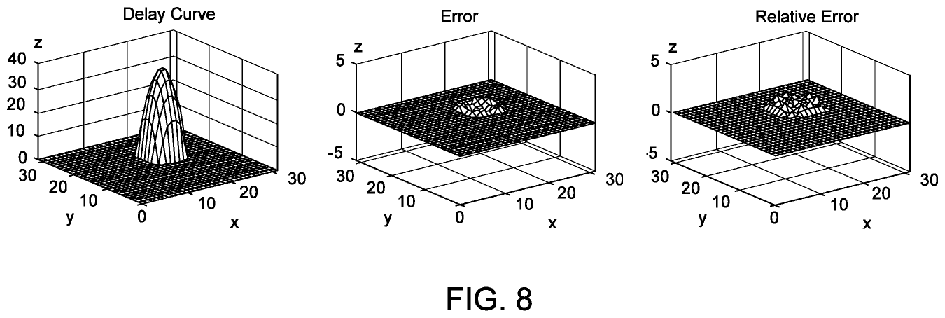

The DDS 108 accesses those registers to generate the delay profile. Further details regarding the generation of the delay profile by the DDS 108 are provided below. In some embodiments, the processor 119 processes the image information based on the scanned area. The scan process proceeds and determines the parameters of the delays based on the size of the space being probed, the materials being probed and the angle that is being probed, for example. In some embodiments, the DDS 108 “masks” a portion of the waveform by calculating the delays only in regions where the delay values are in a selected range. For example, in FIG. 8A, a relatively sharp beam can be formed by masking the delays that are greater than a predetermined value (i.e., only the transducer elements associated with the delays at the protrusion of the delay curve (z greater than 10) will transmit.

The manner in which the DDS 108 is programmed for a particular set of parameters is determined by data provided through either the LVDS subsystem 110 or the SPI slave device 111, each of which couples the die to the FPGA 117. In some embodiments, the processor 119 processes the image information based on the scanned area.

### FPGA/Die Interface

In one embodiment of the disclosed method and apparatus, the die 101 communicates with the FPGA 117 via the SPI interface (i.e., through the SPI slave device 111). The SPI slave device 111 in the die 101 and an SPI master device in the FPGA 117 coordinate the communication. When relatively high data rates are required to communicate some of the information that flows between the die 101 and the FPGA 117 (or any other external resource in other embodiments), the LVDS subsystem 110 provides an alternative to the SPI interface for communicating with the FPGA 117. The LVDS has improved noise immunity over the SPI through the use of differential inputs, thus making it more effective for such high data rates. The differential inputs (i.e., LVDS inputs 148) include inputs for clock, data and address signals. In some embodiments, the LVDS subsystem 110 has electrical characteristics, as determined by the TIA/EIA-644 technical industry standard. Output signals 149 from the LVDS subsystem 110 are sent to the management interface 114. In some embodiments, twisted pairs of wire provide input signals to the LVDS subsystem 110, which interprets the difference between the voltages on each wire of the twisted pairs to detect information being communicated over the LVDS connection. Once received by the LVDS subsystem 110, the clock, address and data signals are converted to single-ended signals that are routed to the management interface 114.

In order to define a waveform to be transmitted into the target region, a delay profile must be generated that determines the relative delays between each of the transmitting transducer elements of the array 102. Generating the number of delay profiles that may be required to generate a desirable image can be processor intensive and may require more processing power, Integrated Circuit (IC) real estate and/or electrical power than it is desireable to make available on the chip on which the dies 101 reside. Accordingly, in some embodiments the external processor 119 is used. In a system 100 in which the delay profile is provided from an outside processing source and in which the system 100 has four dies 101, and further in which each die 101 is associated with 1024 transducer elements, the amount of data required to be transmitted between the FPGA 117 and the die 101 for a complete delay profile is very large, especially when multiplied by the number of waveforms that may be desired to be transmitted to attain a desirable image. The management interface 114 uses the information received from the FPGA 117 to control the die 101. Controlling the die 101 includes (1) triggering the generation of pulses that excite the transducer elements of the array 102; (2) setting the multiplexer 134 to select which paths to select to pass information received from the desired set of transducer elements to the ADC/AFE 114; (3) sending information from which the delay profile can be generated locally; and (4) using a parameter that indicates the amount of time between transmit and receive modes to calculate the transmit and receive timing. Accordingly, the management interface 114 drives (i.e., controls) the DDS 108 and the pulser 104 based on parameters received through the LVDS subsystem 110 and/or the SPI slave device 111. The management interface 114 provides the information received through the LVDS subsystem 110 and/or the SPI slave device 111 to the DDS 108 through registers (not shown). The DDS 108 uses that information to determine the delay profile. The delay profile in turn is used to determine the which particular transducer elements of the transducer array 102 are to be excited to transmit a signal and the relative timing of the transmission from each transducer element.

### Control of Transmit Waveform—Generation of Delay Profile

As noted above, the amount of processing power required to generate the delay profiles locally within the dies 101 is greater than desired. However, the amount of data that needs to be communicated to provide the delay profiles from an external processor is also too great. The presently disclosed method and apparatus provides several ways to reduce the aggregate of the local processing power required while maintaining an acceptable amount of data communicated from an external source.

In some embodiments in which the delay profiles are determined external to the die 101, the amount of data required to be transmitted to the die to provide the delay profiles is reduced by one of the following techniques.

In a first technique, a delay profile generated in the processor 119 is compressed either in the processor 119 or in the FPGA 117, such as by using JPEG2000, for example. Such compression techniques make it easier to resize the number of transmit transducer elements. Furthermore, by reducing the amount of information required to transmit the delay profile, it possible to represent each of the delays in the delay profile with more resolution (i.e., use more bits to represent each delay value). In some embodiments, in addition to, or as part of the compression algorithm, portions of the delay profile with less than a threshold amount of variation may be linearly interpolated without significant loss of accuracy in delays of each transducer element represented in the delay profile.

In other embodiments, interpolation is used by the DDS 108 to determine delay values for transducer elements within an interpolation region that lie physically within the transducer array 102 between two transducer elements for which delay values are present in the low resolution delay profile. An interpolation region refers to a collection of transducer elements for which delay values are required and for which some such values can be determined by interpolation from other values within the interpolation region. Using such interpolation reduces the amount of data to be transmitted from the FPGA 117 to the die 101 by reducing the number of delay values required to be transmitted. In such embodiments, the low-resolution delay profile is communicated from the FPGA 117 to the die. Accordingly, such a low-resolution delay profile includes only a subset of the delay values that are required for properly generating and transmitting a desired waveform. The subset of delay values is then used to determine the other delay values not expressly provided in the low resolution delay profile. It can be seen that it is more efficient to use a lower resolution delay profile (i.e., a profile in which delays are provided for less than all of the transducer elements of the transducer array) and then later interpolate between (or around) the provided delays to attain the delays of those transducer elements for which no delay values were provided in the lower resolution delay profile.

In some embodiments, a technique known as bicubic interpolation is used to determine the delay values that are missing from a low-resolution delay profile.

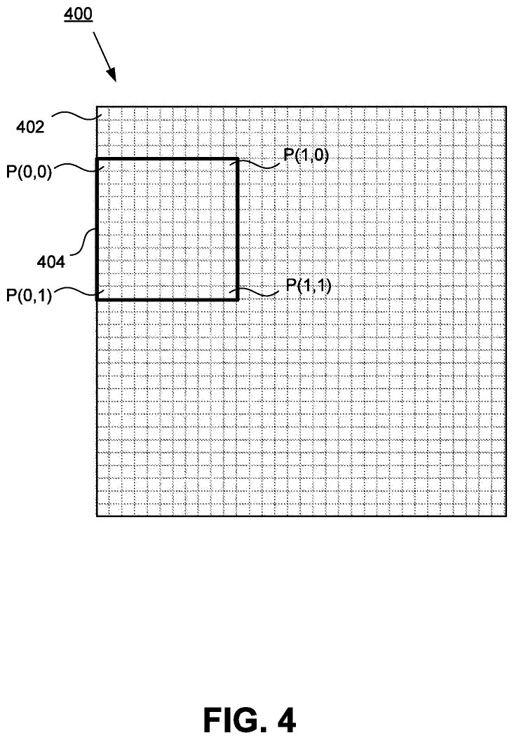

FIG. 4 is an illustration representing the locations 402 of transducer elements in a transducer array 400. The locations 402 of 32×32 transducer elements are shown, each located in the square between two adjacent horizontal and two adjacent vertical lines. An integration region 404 is shown within which delay values for 11×11 transducer elements can be determined using bicubic interpolation. The interpolation region 404 comprises transducer elements at points p(x,y) in a two-dimensional normalized matrix p(0,0):p(1,1), where the transducer element located at p(0,0) resides at the top left of the integration region 404 and the transducer element located at p(1,1) resides at the bottom right of the integration region 404. The transducer element located in the upper right corner is located at p(1,0). The transducer element located in the lower left corner is at p(0,1). The locations of the points in the interpolation region 404 are normalized to simplify operations. Therefore, the transducer element located just to the right of the transducer at p(0,0) is located at p(0.1,0) and the transducer element just to the right of that is located at p(0.2,0). Bicubic interpolation uses the polynomial shown in EQ. 1 to determine the value f(x,y) of any delay for any transducer element located at p(x,y) within the interpolation region 404. An interpolation region of 11×11 is used so that the normalized locations of each point are spaced 0.1 apart for the sake of simplifying this example. However, in many embodiments, the dimensions of the interpolation region will be selected based on more practical considerations, such as selection of a binary number like 32 to make digital computations simpler.

$$f ( x , y ) = {\sum }_{i = 0}^{3} {\sum }_{j = 0}^{3} {a}_{ij} {x}^{i} {y}^{j} \qquad EQ . 1$$

Bicubic interpolation can be performed to determine the value f(x,y) for any value of x and y within the interpolation region when the bicubic coefficients, a_{i,j} are either known or can be determined. The bicubic coefficients characterize the shape of a three-dimensional surface (x, y, f(x,y)) that lies in the interpolation region.

### Bicubic Interpolation Directly from Bicubic Coefficients

The bicubic interpolation polynomial of EQ. 1 includes 16 coefficients, a_{i,j}, with i and j being integers from 0 to 3. Accordingly, these coefficients are: a_{0,0}, a_{1,0} . . . a_{2,0}, a_{2,1} . . . a_{3,3}. The value of these 16 coefficients can be determined if there are 16 independent equations, each comprising the 16 coefficients. For example, if the delay values of 16 different transducer elements within the interpolation region 404 are known, EQ. 1 can be used together with those values to characterize a three-dimensional surface that plots the delay values of each point within the interpolation region 404. Putting in the value of x and y for each point, an equation can be written out for each of the 16 transducer elements, thus providing the required 16 equations from which the values of the 16 coefficients can be calculated. In the case of an interpolation region that covers a set of 11×11 transducer elements (i.e., 121 transducer elements total), the 16 values may be delay values that reside within a low resolution delay profile. A delay profile in which delay values of only 16 of the 121 transducer elements are provided, is referred to a “low resolution” delay profile, since only 16 of the 121 values are provided. In the case in which the processor 119 knows the shape of the waveform to be transmitted into the target region, the delay values for 16 such elements are known by the processor 119. In fact, in some embodiments, the values for all of the transducer elements in the array 102 are known by the processor 119, since either the processor 119 or a user defines the waveform to be transmitted by the transducer elements within the interpolation region 404. It should be understood that the goal is not to determine the delay profile at the processor 119, but rather to convey information from the processor 119 to the die 101 in an efficient manner. The 16 values, each of which represent delay value represented by the interpolation polynomial evaluated at each of the 16 locations associated with the 16 values, form 16 equations. Each such equation comprises the delay value equated to a polynomial with the 16 bicubic interpolation coefficients. Thus, there are 16 independent equations with 16 unknown coefficients, allowing the 16 coefficients can be determined.

It should be noted that in one embodiment, the low resolution delay profile need not be transmitted from the processor 119. Rather, the processor 119 calculates the bicubic interpolation coefficients and sends them to the die 101 via the FPGA 117. The FPGA 117 stores the coefficients in registers that are accessible to the DDS 108. It should be noted that some embodiments in which multiple waveforms are to be transmitted, the FPGA 117 and processor 119 determine the set of coefficients associated with each such waveform. The FPGA 117 provides each set of coefficients to the die 101 and establishes the relative timing, i.e., when each waveform is to be transmitted. For example, one of the delay profiles may be used for sending plane waves in a sequence of directions. The FPGA 117 will provide the coefficients for each such plane wave. In some embodiments, FPGA 117 performs computations that are to be computed relatively rapidly, e.g., within a 10 μs window. The split between the functions performed by the FPGA 117 and the processor 119 depends upon the particular application and desired complexity of each.

In some embodiments, the DDS 108 uses these coefficients and EQ. 1 to calculate the delay for each of the 121 transducer elements, including the 16 delay values that the processor 119 used to calculate the coefficients. Alternatively, the low resolution delay profile having the 16 delay values can be sent to the die 101 instead of the coefficient values and the DDS 108 can use the low resolution delay profile to calculate the 16 coefficients and from them, the remaining 121−16=105 delay values. It should be noted an interpolation region of 11×11 is just one example.

In other embodiments, the knowledge of the shape of the desired waveform to be transmitted can be used by the processor 119 to solve for the 16 coefficients in other ways. In other embodiments, interpolation other than bicubic interpolation may be used in which a different number of delay values may be used to determine a different polynomial, and that polynomial may have a different number of coefficients.

It should be noted that any combination of 16 constraints can be used to determine the bicubic polynomial coefficients. For example, delay values for four transducer elements and associated derivatives of those delay values can be used to determine the coefficients. Selection of the particular combination of constraints may depend upon the shape of the waveform to be transmitted. That is, delay values for transducer elements that each have large derivatives (i.e., the change in the value of the delay at the adjacent transducer element is relatively large) may be selected, or delay values for transducer elements that are within an area of the waveform that is more dynamic (has more contour) might be selected to provide a more accurate interpolation in those regions of the waveform.

In one particular selection of the constraints, the delay values for the transducer elements at the four corners of the interpolation region are provided. In addition, the derivatives of the delay profile at each corner, both with respect to the horizontal direction (i.e., the x-direction), referred to hereafter as ƒₓ and the vertical direction (i.e., the y-direction), hereafter referred to as ƒ_{y} are provided. Still further, either the partial derivate of ƒₓ with respect to y (referred to hereafter as ƒ_{xy}) or the partial derivate of ƒ_{y} with respect to x (referred to hereafter as ƒ_{yx}). If the function values ƒ and the derivatives ƒₓ, ƒ_{y}, and either ƒ_{xy}, or ƒ_{yx} are known at the four corners of the unit square, having corners (0,0), (1,0), (1,0), (1,1), then there will be 16 independent equations that will allow the 16 unknown interpolation coefficients to be determined. It should be noted that the delay profile defines a three dimensional surface with the x and y dimensions indicating the row and column of a transducer element of the array 102. The z dimension is the amount of relative delay with respect to each other transducer element to be applied before the transducer element transmits a signal. Accordingly, the “derivative of the delay” is the derivative of the function for the surface (i.e., waveform) defined by the delay profile. Stated another way, the derivative of the delay with respect to x is the amount of change in the delay from one transducer element to the next moving through the transducers along a row (i.e., in the x direction). Similarly, the derivative with respect to y is the change in the delay from one transducer element to the next moving through the transducer elements along a column (i.e., in the y direction). The partial derivative f_{xy} is the change in the derivative with respect to x as you move along a column (i.e., in the y direction).

The determination of the interpolation coefficients can be made at the processor 119, the FPGA 117 or in the die 101. By determining the interpolation coefficients in the processor 119 or FPGA 117, the amount of information needed to be communicated to the die is minimized. Since the processor 119 will typically have more processing capability, determining the interpolation coefficients at the processor 119 is useful when limiting the amount of information to be communicated to the die 101 is a concern. Using the delay, first derivatives with respect to x and y and the value of f_{xy} (i.e., the partial derivative of fₓ with respect to y), four equations EQ. 2, EQ. 3, EQ. 4, EQ. 5 can be written for each of the four corners, resulting in the 16 equations for determining bicubic interpolation coefficients of the interpolation region.

$$\begin{matrix}f ( x , y ) = {\sum }_{i , j = 0}^{3} {a}_{ij} {x}^{i} {y}^{j} & EQ . 2 \\ {f}_{x} ( x , y ) = {\sum }_{i , j = 0}^{3} {ia}_{ij} {x}^{i} {y}^{j} & EQ . 3 \\ {f}_{y} ( x , y ) = {\sum }_{i , j = 0}^{3} {ja}_{ij} {x}^{i} {y}^{j} & EQ . 4 \\ {xy}_{x} ( x , y ) = {\sum }_{i , j = 0}^{3} {ija}_{ij} {x}^{i} {y}^{j} & EQ . 5\end{matrix}$$

In some embodiments, the values of the derivatives of the delay profile at the corners of the interpolation region are determined in the processor 119. In some embodiments, the derivatives are determined in the processor 119 by a numerical approximation. Ensuring that the derivatives at two adjoining interpolation regions have the same first derivatives at the adjoining edge of the interpolation region can help make smooth transitions between adjoining interpolation regions. It should be noted that constraints other than those noted above can be used to determine the polynomial coefficients.

Once the coefficients are determined, all of the unknown delay values of the transducer elements presented in the delay profile can be computed from EQ. 1.

In embodiments in which the coefficients a₀₀ . . . a₃₃ represent the values for a normalized interpolation region, the bicubic polynomial coefficients for an interpolation region that is spaced apart by the actual distance of the transducer element in the array 102 can be determined as follows. The actual position (x, y) of the transducer elements can be represented as x=mΔx and y=nΔy, where:
m and n are integers representing the row and column identifying the transducer element at that position;
Δy is the actual distance between neighboring rows of the transducer array; and
Δx is the actual distance between neighboring columns of the transducer array.
   When the array is set on a square grid, such that the distance between adjacent transducer elements in each row and the distance between adjacent transducer elements in the each column are the same the following identity can be defined:

Δx=Δy=δ

When this is true, the values of the coefficients for the delay profile are:

$${α}_{mn} = {a}_{mn} {δ}^{n + m}$$

and the bicubic interpolation polynomial for determining the delay profile for this interpolation region is:

$$f ( m , n ) = {\sum }_{i = 0}^{3} {\sum }_{j = 0}^{3} {α}_{ij} {m}^{i} {n}^{j} \qquad EQ . 6$$

In the above polynomial, the values of m spans the values, m=0, 1, 2, . . . mₘₐₓ and the value of n spans the values, n=0, 1, 2, . . . nₘₐₓ where nₘₐₓ+1 and nₘₐₓ+1 are the number of transducers along the width and length of the transducer array 102, respectively.

In some embodiments, calculating the 16 coefficients αᵢⱼ of the interpolation polynomial which takes into account the physical dimensions of the transducer array 102 is performed within the processor 119.

In some embodiments, such as those in which the array system 100 combines more than 1 die into a package, creating the delay profile using bicubic interpolation results in smooth transitions between the delays for a set of transducer elements that is adjacent to another set of transducer elements, each set of transducer element having their delays provided in a different “adjacent” delay profile. The system 100 can load multiple delay profiles, each representing an “aperture” through which a waveform can be transmitted. In some embodiments, some apertures straddle or are within a portion of the transducer array that is under the control of different dies. Nonetheless, the resulting reflected signals can be “stitched together” to create an image with a smooth transitions between the various received reflected signals. It should be noted that the size and location of the transmit aperture and the receive aperture are independent.

In some embodiments, the size of the aperture (e.g., the size of the delay profile) can be adjusted to include all of the transducer elements of the entire array 102 or to just a portion of the array 102, e.g., from 8×8 pixels to 64×64 pixels. In addition, the apertures that are smaller than the full array 102 can be include transducer elements that are located at arbitrary locations of the array 102 (i.e., include selected transducer elements that are distributed throughout the array 102 or clustered within portions of the array 102). In some embodiments, multiple dies 101 work together to form a larger aperture under the control of the FPGA 117 and/or the processor 119. In some embodiments, portions of apertures that span multiple dies 101 are kept consistent with one another by interpolating to produce a delay profile for apertures that straddle multiple dies. In some embodiments, apertures can be formed between dies 101 that lie within different integrated circuit chips or packages.

Some apertures may include more than one interpolation region. Some interpolation regions may include multiple apertures. In some embodiments, the higher order polynomial terms (e.g., of the bicubic interpolation function) facilitate interpolating higher order delay curves, wedges, or immersion imaging.

### Efficient Method for Calculation of Transducer Element Delays

Providing the bicubic interpolation coefficients to the die 101 allows the DDS 108 of the die 101 to determine the delay for each of the transducer elements within an interpolation region without requiring a large amount of data to be communicated to the die 101 and with relatively little computation on the die 101. However, several multiplication operations still need to be performed on the die 101 in order to determine the delay values from the bicubic polynomial. In general, addition operations can be performed more efficiently (i.e., with fewer gate and less power consumption) than multiplication operations.

In accordance with one embodiment of the disclosed method and apparatus, additional techniques disclosed herein can be used to reduce the number of multiplication operations required to determine the delay values for the transducer elements. For example, in some embodiments, the DDS 108 uses the delay value of a first transducer element located at position 0,0 of the interpolation region and derivatives of the function shown in EQ. 6 to determine a second delay value associated with a second transducer element that is located immediately adjacent to the first transducer element. As noted above, EQ. 6 is the bicubic polynomial that characterizes the set of delays required to produce the waveform to be transmitted.

In accordance with the one embodiment of the disclosed method and apparatus, the delay associated with a second transducer element that resides adjacent (i.e., either to the right or below) the transducer element located at the corner of an interpolation region is determined by the DDS 108 as follows.

The derivative ƒₘ(m,n), is evaluated at the corner. The value of the definite integral of the derivative ƒₘ(m,n) over the interval between the first and second transducer is then determined. Since the integral is essentially the inverse operation of the derivative, the result of the integration can be used in determining the value of the delay associated with the transducer element located at the second point adjacent to the comer. This assumes that the value of the delay associated with the transducer at the corner is known (as is the case here). This can be expressed by the following equations:

$${\int }_{0 , 0}^{1 , 0} {f}_{m} ( m , n ) = f ( 1 , 0 ) - f ( 0 , 0 ) \qquad EQ . 7$$

EQ. 7 states that the definite integral of the first derivative of the function of EQ. 6 taken over the interval from ƒ(0,0) to ƒ(1,0) is equal to the delay of the transducer element adjacent to the corner (i.e., ƒ(1,0)) minus the delay of the transducer element at the corner (i.e., ƒ(0,0)). Furthermore, the definite integral can also be evaluated using the well-known trapezoidal rule for integration, which says that the definite integral is equal to half the sum of the derivatives evaluated at the two ends of the integration interval:

$${\int }_{0 , 0}^{1 , 0} {f}_{m} ( m , n ) = \frac{{f}_{m} ( 0 , 0 ) + {f}_{m} ( 1 , 0 )}{2} \qquad EQ . 8$$

Where ƒₘ(m,n) is the first derivative of the function ƒ(m,n) with respect to m. Combining EQ. 7 and EQ. 8 results in:

$${\int }_{0 , 0}^{1 , 0} {f}_{m} ( m , n ) = f ( 1 , 0 ) - f ( 0 , 0 ) = \frac{{f}_{m} ( 0 , 0 ) + {f}_{m} ( 1 , 0 )}{2} \qquad EQ . 9$$

Solving for ƒ(1,0) results in:

$$f ( 1 , 0 ) = \frac{{f}_{m} ( 0 , 0 ) + {f}_{m} ( 1 , 0 )}{2} + f ( 0 , 0 ) \qquad EQ . 10$$

All of the terms on the right side of EQ. 10 can be easily determined. That is, both the delay value and the first derivative of the function of EQ. 6 at f(0,0), as well as the derivative of EQ. 6 with respect to m evaluated at f(1,0) can be easily determined as follows. For the transducer element located at (0,0), both m and n equal zero. Therefore, the delay associated with the transducer element at the corner ƒ(0,0) is:

$$f ( m , n ) = {α}_{00} + {α}_{10} m + {α}_{01} n + {α}_{11} mn + {α}_{20} {m}^{2} + {α}_{02} {n}^{2} + {α}_{21} {m}^{2} n + {α}_{12} {mn}^{2} + {α}_{22} {m}^{2} {n}^{2} + {α}_{30} {m}^{3} + {α}_{03} {n}^{3} + {α}_{13} {mn}^{3} + {α}_{31} {m}^{3} n + {α}_{32} {m}^{3} {n}^{2} + {α}_{23} {m}^{2} {n}^{3} + {α}_{33} {m}^{3} {n}^{3} \to f ( 0 , 0 ) = {α}_{00} \qquad EQ . 11$$

It can be seen that all of the terms in EQ. 11 have either m or n or both and therefore are equal to zero, except the first term, α₀₀. The first derivative of ƒ(m,n) with respect to m is:

$${f}_{m} ( m , n ) = {α}_{10} + {α}_{11} n + 2 {α}_{20} m + 2 {α}_{21} mn + {α}_{12} {n}^{2} + 2 {α}_{22} {mn}^{2} + 3 {α}_{30} {m}^{2} + {α}_{13} {mn}^{3} + 3 {α}_{31} {m}^{2} n + 3 {α}_{32} {m}^{2} {n}^{2} + 2 {α}_{23} {mn}^{3} + 3 {α}_{33} {m}^{2} {n}^{3} \qquad EQ . 12$$

Evaluating ƒₘ(m,n) at the position (0, 0) results in an equation in which all of the terms but the first are a product of either m or n, therefore the result is:

$${f}_{m} ( 0 , 0 ) = {α}_{10} \qquad EQ . 13$$

The first derivative with respect to m at the position (1, 0) is:

$${f}_{m} ( 1 , 0 ) = {α}_{10} + 2 {α}_{20} + 3 {α}_{30} \qquad EQ . 14$$

The only terms in EQ. 12 that are not zeroed out by being multiplied by n are the first, third and seventh terms. Applying EQ. 11, EQ. 12 and EQ. 13 to EQ. 10 allows the value for the delay of the second transducer element to be determined as:

$$f ( 1 , 0 ) = \frac{{α}_{10} + 2 {α}_{20} + 3 {α}_{30}}{2} + {α}_{00} \qquad EQ . 15$$

Since the value of each of the 16 bicubic coefficients α_{m,n} are known to the DDS 108, having been downloaded by the processor 119 and FPGA 117 to the die 101, the delay value for the second transducer element is easily determined using only addition operations, a single divide by 2 operation and a single multiply by 3 operation. While for the transducer element located at location (0,1) it would be relatively easy to determine, this is not the case for other values of m and n.

For example, to compute the value at the point ƒ(2,4) (i.e., the fourth transducer element in the second row) using the previously determined delay value of the transducer element to the left within the same row (i.e., ƒ(1,4)), EQ. 7 is rewritten for the points ƒ(1,4) and ƒ(2,4) as:

$${\int }_{1 , 4}^{2 , 4} {f}_{m} ( m , n ) = f ( 1 , 4 ) - f ( 2 , 4 ) \qquad EQ . 16$$

This definite integral can be evaluated using the trapezoidal rule. As will be explained in more detail below, when at least two adjacent points have been previously determined, it is possible to get a more accurate evaluation of the integral using Simpson's rule. However, for simplicity in making the current point, the trapezoidal rule is used.

$${\int }_{1 , 4}^{2 , 4} {f}_{m} ( m , n ) = \frac{{f}_{m} ( 1 , 4 ) + {f}_{m} ( 2 , 4 )}{2} \qquad EQ . 17$$

Evaluating EQ. 12 (which shows ƒₘ(m,n)) at the two points ƒ(1,4), ƒ(2,4), we see that the terms that are required to determine the value of EQ. 18 have several terms remaining, and the complexity of the multiplications required grows significantly from that shown above with regard to the determining the value at the point ƒ(1,0) using the corner ƒ(0,0).

$$\begin{matrix}{f}_{m} ( 1 , 4 ) = {α}_{10} + {α}_{11} ( 4 ) + 2 {α}_{20} + 2 {α}_{21} ( 4 ) + {{α}_{12} ( 4 )}^{2} + 2 {{α}_{22} ( 4 )}^{2} + 3 {α}_{30} + {{α}_{13} ( 4 )}^{3} + 3 {α}_{31} ( 4 ) + 3 {{α}_{32} ( 4 )}^{2} + 2 {{α}_{23} ( 4 )}^{3} + 3 {{α}_{33} ( 4 )}^{3} & EQ . 18 \\ {f}_{m} ( 2 , 4 ) = {α}_{10} + {α}_{11} ( 2 ) + 2 {α}_{20} ( 4 ) + 2 {α}_{21} ( 8 ) + {{α}_{12} ( 4 )}^{2} + 2 {α}_{22} 2 {( 4 )}^{2} + 3 {α}_{30} {2}^{2} + {α}_{12} 2 {( 4 )}^{3} + 3 {α}_{21} {2}^{2} ( 4 ) + 3 {α}_{22} {2}^{2} {4}^{2} + 2 {α}_{23} 2 {( 4 )}^{3} + 3 {α}_{33} {2}^{2} {4}^{3} & EQ . 19\end{matrix}$$

It should be clear from this example that for most values of ƒ(m,n), the number of multiplications is significant. However, by continuing to take higher order derivatives until resulting value is a constant (independent of both m and n), the number and complexity of the multiplications is significantly reduced. Since that derivative is not dependent on the value of m, that derivative will have the same value for all values of m, i.e., for all locations across the same row of the array of transducer elements 102. Furthermore, the equation for determining a lower order derivative at a location in the array from a higher order derivative evaluated at an adjacent location and from a derivative of the same order evaluated at the adjacent location is:

$${f}_{m} ( m + 1 , n ) = \frac{{f}_{mm} ( m , n ) + {f}_{mm} ( m + 1 , n )}{2} + {f}_{m} ( m , n ) \qquad EQ . 20$$

Where ƒₘₘ(m,n) is the second derivative of ƒ(m,n) with respect to m. The example provided here shows that the first order derivative at a first location adjacent to a second location can be determined from the sum of the next higher order derivatives for the two adjacent locations, the sum divided by 2 and summed with the lower order derivative for the second location. If the higher order derivative is a constant, then:

$${f}_{mm} ( m , n ) = {f}_{mm} ( m + 1 , n ) \qquad EQ . 21$$

$$Consequently :$$

$$\frac{{f}_{mm} ( m , n ) + {f}_{mm} ( m + 1 , n )}{2} = \frac{{f}_{mm} ( m , n ) + {f}_{mm} ( m , n )}{2} = {f}_{mm} ( m , n )$$

Substitution into EQ. 20 results in:

$${f}_{m} ( m + 1 , n ) = {f}_{mm} ( m , n ) + {f}_{m} ( m , n ) \qquad EQ . 23$$

EQ. 23 states that the value of a derivative evaluated at a first location is equal to the value of the next higher derivative evaluated at an adjacent location plus the value of a derivative of the same order evaluated at the adjacent location if the higher order derivative is a constant derivative (i.e., is independent of the variable over which the derivative is taken).

Furthermore, in some embodiments, a table of higher order constant derivatives of EQ. 6 can be provided to the die 101 to reduce the need for the DDS 108 within the die 101 to directly determine the values of those constants.

Once a derivative having a constant value with respect to n and m is determined, the next lower derivatives can be successively determined until arriving at the value of the delay for the particular location.

For example, the second derivative at a first location (m,n) and a second adjacent location (m−1,n) can be used to compute the first derivative at the second location as follows, where ƒₘₘ(m,n) is the second derivative of ƒ(m,n) with respect to m:

$${f}_{m} ( m , n ) = {f}_{m} ( m - 1 , n ) + \frac{{f}_{mm} ( m - 1 , n ) + {f}_{mm} ( m , n )}{2} \qquad EQ . 24$$

If the second derivative is not a constant, the value of the second derivative can be determined using higher order derivatives as shown in EQ. 23. If the next higher order derivative is also not a constant, then the next higher order derivatives can be used to determine that derivative, and so on.

However, because the integration used to determine the value of the delay for the transducers across the array 102 is performed by an approximation (i.e., using the trapezoidal rule for integration), there is an integration error that builds up as the values are determined for each delay across the array 102. That is, since there is an error in the estimation of the second delay value, that error is brought forward into the calculation of the third delay value, and so on. This error can be reduced by using Simpson's rule for integration to determine the those delay values for which at least two adjacent delay values have been previously determined.

The difference between the trapezoidal rule and Simpson's rule is that in the trapezoidal rule, the portion of the surface that lies between the points is considered straight. In Simpson's, the portion of the surface that lies between the points is considered parabolic. In addition, in the trapezoidal rule there is no limitation on the number of points into which the area being integrated is divided. However, in Simpsons, the number of divisions should be even. Furthermore, the trapezoidal rule gives an approximate result, whereas Simpson's rule gives an accurate result. The results obtained by Simpson's rule are more accurate, but require more points to be considered to attain the result in order to take the curvature of the surface into account.

In the present case, using Simpson's rule requires using 2 adjacent locations in the array 102 that have been previously resolved, unlike the trapezoidal rule, which uses just one adjacent previously resolved location. As an example, keeping m constant, the delay value f(2,0) may be computed by integrating the first derivative as follows:

$$\begin{matrix}{\int }_{0 , 0}^{2 , 0} {f}_{m} ( m , n ) = f ( 2 , 0 ) - f ( 0 , 0 ) = \frac{{f}_{m} ( 0 , 0 ) + 4 {f}_{m} ( 1 , 0 ) + {f}_{m} ( 2 , 0 )}{3} & EQ . 25 \\ f ( 2 , 0 ) = f ( 0 , 0 ) + \frac{{f}_{m} ( 0 , 0 ) + 4 {f}_{m} ( 1 , 0 ) + {f}_{m} ( 2 , 0 )}{3} & EQ . 26\end{matrix}$$

If the derivative in EQ. 26 is a constant, then:

$${f}_{m} ( 0 , 0 ) = {f}_{m} ( 1 , 0 ) = {f}_{m} ( 2 , 0 ) \qquad EQ . 27$$

And so:

$$f ( 2 , 0 ) = f ( 0 , 0 ) + \frac{6 {f}_{m} ( 0 , 0 )}{3} = f ( 0 , 0 ) + 2 {f}_{m} ( 0 , 0 ) \qquad EQ . 28$$

Accordingly, the DDS 108 can determine a third adjacent delay from the sum of the delay value for the first location and two times the derivative evaluated at the first location, assuming the derivative is a constant derivative. If not, then EQ. 28 can be used to determine a derivative evaluated at the third adjacent location from the sum of the same order derivative evaluated at the first adjacent location plus twice the next higher order derivative which is a constant. The DDS 108 repeats this process for the delay associated with each transducer element in the row across the array 102. Once the values of one complete row are determined, the delay value for the left most location of the next row can be determined from the location just above and then used to determine each of the values in a second row that is adjacent to the first row. The DDS 108 repeats that process until the delay values for all of the rows and columns of the delay profile have been determined.

The delay of the second transducer element is determined using far less multiplication operations than are required to determine the delay of the second transducer element directly from the bicubic polynomial.

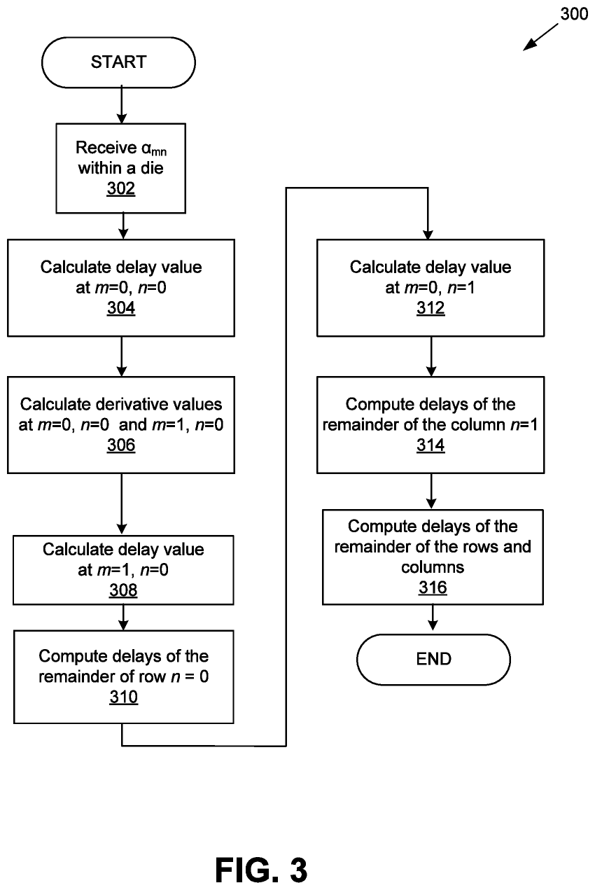

FIG. 3 illustrates one embodiment of a method for computing the delay for each of the transducer elements of a delay profile within an interpolation region. Initially, the polynomial coefficients are provided to the die 101 by the FPGA 117 (STEP 302). In some embodiments, values for the delay at an initial location is determined based on the 16 bicubic coefficients α₀₀ . . . α₃₃ of equation EQ. 6. The each transducer element has coordinates m and n, where m is an integer having a value from 0 to one minus the total number of transducer elements in a row and n is an integer having a value from 0 to one minus the total number of transducer elements in a column. In some embodiments, the initial location is ƒ(0,0) (STEP 304). The delay determined by the function ƒ(m,n) in the EQ. 6 above defines the surface of the waveform to be transmitted. Next, the first derivative for EQ. 6 is determined and evaluated at the corner ƒ(0,0) and the first derivative ƒₘ(1,0) of the interpolation polynomial in EQ. 6 for the transducer element at the next location (1,0) (STEP 306).

In addition, the delay value of the transducer element at the next location ƒ(1,0) is determined (STEP 308). In some embodiments, this is the sum of ƒₘ(1,0) and ƒₘ(0,0) divided by 2 and added to the delay value ƒ(0,0) for the transducer element at (0,0) as shown above in EQ. 10. That is, the delay of each transducer element of the first row is determined using the integral of the derivative of the function of EQ. 6. The definite integral is evaluated between the locations of the prior transducer element in the row and the current transducer element (i.e., the element for which the delay value is currently being sought). The value of this definite integral can be determined from the sum of the derivative of the function at the prior location and the derivative of the function at the current location and dividing this sum by 2. The value of the integral is then added to the delay value of the transducer at the prior location to determine the delay value of the current location.

Next, the delays for the rest of the first row n=0 is determined (STEP 310). Each delay in the first row can be determined from the first derivative of the function shown in EQ. 6 determined between the previous location and the current location together with the delay of the previous location. However, where the first derivative is not a constant, the value for the first derivative can be determined by taking successive derivatives, until a constant is attained (i.e., a “constant derivative” is attained). The constant derivative can then be integrated over the interval between the previous location and the current location to determine a value for the next lower derivative, similar to the manner in which the first derivative is integrated over the interval to determine the delay value. That is, from EQ. 8 above, we see that the definite integral of a function for the interval between two locations is the value of the derivative of the function evaluated at the first location plus value at the derivative of the function evaluated at the second location divided by 2. If the derivative of the function being integrated is a constant, then the values at both locations will be the same and the integral will equal to the derivative at the previous location. This process of attaining the value for the next lower derivative can be repeated until the first derivative is attained, which can then be used to attain the delay value for the current location.

The value at (0,1) is determined from the value at (0,0) and the derivatives similar to the manner in which the value at (1,0) was determined (STEP 312). The values down the first column (i.e., (m=1, n=j), where j has values from 0 to M−1 and M is the number of transducer elements in a column), are each determined in essentially the same way as the delays of the first row (i.e., (m=i, n=1), where i has values from 0 to N−1 and N is the number of transducer elements in a row) (STEP 314).

Having determined the values in the first row and the first column, the process can proceed either row by row, building on the value in the first column of each row, or alternatively, column by column, building on the first row in each column. In the example shown, the process determines the values row by row after having the first row and the first column completed (STEP 316).

It should be noted that Simpson's rule is used instead of the trapezoidal rule for the integration whenever there are at least two adjacent values that are known. For example, using the ⅓ Simpson's rule

$$f ( m + 2 , n ) = f ( m , n ) + \frac{{f}_{m} ( m , n ) + 4 f ( m + 1 , n ) + f ( m + 2 , n )}{3} ,$$

where ƒ(m+1, n) is the value of the derivative at a midpoint between ƒ(m,n) and ƒ(m+2,n). In some embodiments, the midpoint can be computed using the trapezoidal rule. In some embodiments, although the delay value of the midpoint is computed, the delay value is not applied. In other embodiments, the delay value of the midpoint is applied. For example, to start the process, the polynomial is evaluated at coordinates (0, 0), (0, 1), (1, 0), and (1, 1) are evaluated directly (which requires no multiplication. Then the delay value at the position (0, 2) can be evaluated based on positions (0, 0), (0, 1), using (0, 1) as the midpoint. Similarly, the delay value at the position (0, 3) can be evaluated based on positions (0, 1) and (0, 2), using (0, 2) as the midpoint. Similarly, the integration can be performed along the entire x=0 column and x=1 column. Then the positions along each row can be integrated starting with determining the positions in the x=2 column, based on the positions at the x=0 column and the x=1 column, using the positions at the x=1 column as the midpoints.

More generally, when integrating in the x-direction,

$${f}_{mn} ( m , n ) = {f}_{m} ( m , n ) + {\int }_{m}^{m + 1} \frac{{\partial }^{n + 1}}{\partial {x}^{n + 1}} \frac{{\partial }^{m}}{\partial {x}^{m}} v ( x , y ) dx .$$

When integrating in the y-direction,

$$\frac{{\partial }^{n}}{\partial {x}^{n}} \frac{{\partial }^{m}}{\partial {x}^{m}} v ( x = {n}_{b} Δ x ) = \frac{{\partial }^{n}}{\partial {x}^{n}} \frac{{\partial }^{m}}{\partial {x}^{m}} v ( x = {n}_{a} Δ x ) + {\int }_{Δ x ( {n}_{a} )}^{Δ x ( {n}_{b} )} \frac{{\partial }^{n}}{\partial {x}^{n}} \frac{{\partial }^{m + 1}}{\partial {x}^{m + 1}} v ( x , y ) dy .$$

### Bicubic Computation

### X-Integration

The following formulas are used to derive the 5^{th} order derivative terms from the 6^{th} order derivative. Fourth derivatives with respect to x and the fourth-order derivatives with respect to y are always 0, and consequently,
ƒ_{yyyyx}=ƒ_{yyyyy}=ƒ_{yxxxx}=ƒₓₓₓₓₓ=0 for all iterations. Using ƒ_{xyyyxx}, ƒ_{xyyyx} can be computed as

ƒ_{xyyyx}=ƒ_{xyyyx,previous}+ƒ_{xyyyxx} (5^{th} order x-integration #1),

where during x-integration, “previous” refers to the previous row. During the y integration, “previous” refers to the previous column.

During all iterations, ƒ_{xyyyxx}=36α₃₃, for all permutations of derivatives with respect to x and y. Similarly, for all iterations, during x-integration,
ƒ_{xyxyx}=ƒ_{xyxyx,previous}, because any third derivatives of x are not functions of x (5^{th} order x-integration #2). Also,

ƒ_{yyxyx}=ƒ_{yyxyx,previous}+ƒ_{yyxyxx} (5^{th} order x-integration #3).

However, in general,
ƒ_{yyxyx}=ƒ_{xyyyx}, because the order of differentiation is interchangeable. Further, ƒ_{xxyyx}=ƒ_{xxyyx,previous}, because ƒ_{xxyyx} is not a function of x (5^{th} order x-integration #4). The third derivatives of x are constants during the x integration.

The following formulas are used to derive the 4th order derivatives from the fifth order derivatives,
ƒ_{xxxy}=ƒ_{xxxy,previous} because ƒ_{xxxy} is not a function of x (4rth order x-integration #1), and

ƒ_{xxyy}=ƒ_{xxyy,previous}+ƒ_{xxyyx} (4rth order x-integration #2).

The value of ƒ_{xxyyx} was computed above, with the other 5^{th} derivatives. Also, ƒ_{xxyyx} is not a function of x, and therefore the last value that was computed may be used. Also, ƒ_{xxyyx} does not need to be recomputed for each row (column) during the integration over x. Likewise,

$${f}_{yyxy} = {f}_{yyxy , previous} + \frac{{f}_{yyxyx} + {f}_{yyxyx , previous}}{2} ( 4 rth order x - integration \# 3 ) .$$

The values of v_{yyxyx} was evaluated above. Also,

ƒ_{xyxy}=ƒ_{xyxy,previous}+ƒ_{xyxyx} (4rth order x-integration #4).

In some embodiments, instead of computing ƒ_{xyxy}, one may use the relationship, ƒ_{xyxy}=ƒ_{xxyy}. The value ƒ_{xyxyx}=ƒ_{xxyyx}, which was computed above. The value v_{xyxyx} is not a function of x. Therefore, the prior value may be used for performing the x-integration. Consequently, ƒ_{xyxyx} does not need to be computed during the x-integration.

The following formulas are used to derive 3rd order derivatives from 4rth order derivatives.

The formula for ƒₓₓₓ is

vₓₓₓ=v_{xxx,previous}+ƒₓₓₓₓ (third order x-integration #1).

ƒ_{xyx}=ƒ_{xyx,previous}+ƒ_{xyxx} (third order x-integration #2).

The value ƒ_{xyxx}=ƒ_{xxxy}, which was computed above.

$${f}_{xyy} = {f}_{xyy , previous} + \frac{{f}_{xyxy} + {f}_{xyxy , previous}}{2} ( third - order x - integration \# 3 ) ,$$

ƒ_{xyxy} was computed above.
ƒ_{xxy}=ƒ_{xyx,previous}+ƒ_{xxxy}, where ƒ_{xxxy} was computed above. Note that ƒ_{xyx} should be the same as ƒ_{xxy} and so only one of ƒ_{xyx} and ƒ_{xxy} needs to be computed.

$${f}_{yyx} = {f}_{yyx , previous} + \frac{{f}_{xxyy} + {f}_{xxyy , previous}}{2} ( third - order x - integration \# 4 ) ,$$

which is computed now for use in the y-integration.

$${f}_{yyy} = {f}_{yyy , previous} + \frac{{f}_{yyxy} + {f}_{yyxy , previous}}{2} ( third - order x - integration \# 5 ) ,$$

which is computed now for use in the y-integration. The value of ƒ_{yyxy} of was computed above.

The following formulas are used to derive 2nd order derivatives from third-order derivatives,

ƒₓₓ=ƒ_{xx,previous}+ƒₓₓₓ (second-order x-integration #1).

The value ƒₓₓₓ was computed with the third-order derivatives (and is a constant during x-integration). Also,

$${f}_{xy} = {f}_{xy , previous} + \frac{{f}_{xyx} + {f}_{xyx , previous}}{2} ( second - order x - integration \# 2 ) .$$

The value ƒ_{xyx} was computed with the third-order derivatives. Similarly,

$${f}_{yy} = {f}_{yy , previous} + \frac{{f}_{yyx} + {f}_{yyx , previous}}{2} ( second - order x - integration \#3 ) .$$

The value ƒ_{yyx} was computed with the third-order derivatives. The value ƒ_{yy} is computed now for use in the y-integration.

The following formulas are used to derive first-order derivatives from second-order derivatives,

$${f}_{x} = {f}_{x , previous} + \frac{{f}_{xx} + {f}_{xx , previous}}{2} ( first - order x - integration \#1 ) ,$$

and

$${f}_{y} = {g}_{y , previous} + \frac{{f}_{xy} + {f}_{xy , previous}}{2} ( first - order x - integration \#2 ) .$$

The value of ƒ_{y} is usable during the y-integration. The values of ƒ_{xy} and ƒₓₓ were computed with the second-order derivatives. The value of ƒ_{y} is computed now for use in the y integration.

The following formula is used to derive ƒ(x, y) from the first-order derivatives,

$$f = {f}_{previous} + \frac{{f}_{x} + {f}_{x , previous}}{2} ,$$

the values of ƒₓ was computed with the other first derivative above.

The values of each row are stored for use as previous values when computing the next row. The previous values are used for computing the delay values of the next row or for integration along the columns.

### Y-Integration

In some embodiments, next, the integration is performed along the y-direction, nₓ is held constant.

The following formulas are used to derive the 5^{th} order derivative terms from the 6^{th} order derivative,

ƒ_{xyyyx}=ƒ_{xyyyx,previous} (5^{th} order y-integration #1).

The value, ƒ_{xyyyx} is constant during y-integration.

ƒ_{xyxyx}=ƒ_{xyxyx,previous}+ƒ_{xyxyxy} (5^{th} order y-integration #2),

as mentioned above ƒ_{xyxyxy}=36a₃₃. Also,

ƒ_{xxyyx}=ƒ_{xxyyx,previous}+ƒ_{yyxyxx} (5^{th} order y-integration #3), and

ƒ_{yyxyx}=ƒ_{yyxyx,previous} (5^{th} order y-integration #4).

The values, ƒ_{yyxyx}=ƒ_{xyyyx}, which are constants during y-integration. The following formulas are used to derive the 4^{rth} order derivative terms from the 5^{th} order derivative,

$${f}_{xxxy} = {f}_{xxxy , previous} + \frac{{f}_{xxyyx} + {f}_{xxyyx , previous}}{2} ( 4 rth order y - integration \#1 ) .$$

The ƒ_{xxyyx} was computed just above. Likewise,

$${f}_{xxyy} = {f}_{xxyy , previous} + \frac{{f}_{yyxyx} + {f}_{yyxyx , previous}}{2} ( 4 rth order y - integration \#2 ) .$$

The value ƒ_{yyxyx} was computed above. Similarly,

$${f}_{xyxx} = {f}_{xyxx , previous} + \frac{{f}_{xyxyx} + {f}_{xyxyx , previous}}{2} ( fourth - order y - integration \#3 ) .$$

The value ƒ_{xyxyx} was computed above with the 5^{th} order derivatives.

ƒ_{xyxy}=ƒ_{xyxy,previous}+ƒ_{xyyyx}(note ƒ_{xyyyx}=ƒ_{xyxyy}) (fourth-order y-integration #4).

ƒ_{yyxy}=ƒ_{yyxy,previous} (4rth order y-integration #5),

which is a constant during y-integration.

ƒ_{xyyy}=ƒ_{xyyy,previous} (4rth order y-integration #6),

which is also a constant and should be equal to ƒ_{yyxy}.

The following formulas are used to derive the 3^{rd} order derivative terms from the 4^{th} order derivative,

$${f}_{xxx} = {f}_{xxx , previous} + \frac{{f}_{xxxy} + {f}_{xxxy , previous}}{2} ( 3 rd order y - integration \#1 ) .$$

The value ƒ_{xxxy} was computed with the fourth-order derivative. Also,

$${f}_{xxy} = {f}_{xxy , previous} + \frac{{f}_{xxyy} + {f}_{xxyy , previous}}{2} ( 3 rd order y - integration \#2 ) .$$

The value ƒ_{xxyy} was computed with the fourth-order derivative. Additionally,

ƒ_{yyx}=ƒ_{yyx,previous}+ƒ_{yyxy} (3rd order y-integration #3),

The value of ƒ_{yyxy} was computed above during the x-integration. Similarly,

$${f}_{xyx} = {f}_{xyx , previous} + \frac{{f}_{xyxy} + {f}_{xyxy , previous}}{2} ( 3 rd order y - integration \#4 ) .$$

The value ƒ_{xyxy} was computed above with the fourth derivatives. Also,

ƒ_{xyy}=ƒ_{xyy,previous}+ƒ_{xyyy} (3rd order y-integration #5).

The value ƒ_{xyyy} was computed during the x-integration and is a constant during the y-integration. Also,

ƒ_{yyy}=ƒ_{yyy,previous} (3rd order y-integration #6),

which is also a constant during y-integration.

The following formulas are used to derive the 2^{nd} order derivative terms from the 3^{rd} order derivative,

$${f}_{xx} = {f}_{xx , previous} + \frac{{f}_{xxy} + {f}_{xxy , previous}}{2} ( 2 nd order y - integration \#1 ) .$$

The value of ƒ_{xxy} was computed above, with the third-order derivatives. Similarly,

ƒ_{yy}=ƒ_{yy,previous}+ƒ_{yyy} (2nd order y-integration #2).

The value of ƒ_{yyy} was computed above, with the third-order derivatives.

$${f}_{xy} = {f}_{xy , previous} + \frac{{f}_{xyy} + {f}_{xyy , previous}}{2} ( 2 nd order y - integration \#3 ) .$$

The value of ƒ_{xyy} was computed above with the third-order derivatives.

The following formulas are used to derive the first-order derivative terms from the 2^{nd} order derivative,

$${f}_{x} = {f}_{x , previous} + \frac{{f}_{xy} + {f}_{xy , previous}}{2} ( first order y - integration \#1 ) ,$$

and

$${f}_{y} = {f}_{y , previous} + \frac{{f}_{yy} + {f}_{yy , previous}}{2} ( first order y - integration \#2 ) .$$

The values of ƒ_{yy} and ƒ_{xy} of were computed above with the second-order derivatives.

The following formula is used to derive v from the first derivatives,

$$f = {f}_{previous} + \frac{{f}_{y} + {f}_{y , previous}}{2} ,$$

ƒ_{y} was computed just above.

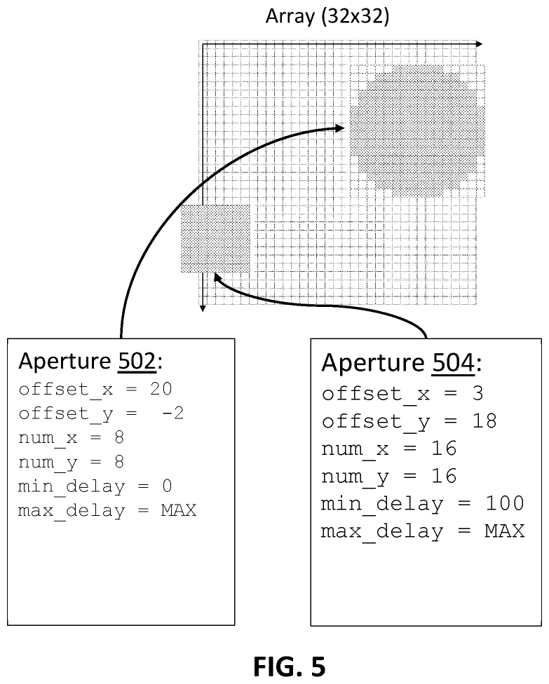

FIG. 5 illustrates an array 500 having examples of regions of the transducer array used for two apertures (apertures 502 and 504) for which the delay profile may be computed. The aperture is used to transmit beams whose reflection is received by any of the transducer elements of the array, and multiple apertures may be implemented simultaneously on the same die. The transducer elements within the aperture are excited to generate an ultrasound beam. The delay profile for the transducer elements within the aperture is computed. The delay profile for the transducer elements in the aperture may be characterized by the offset, which may be the x and y coordinates identifying the location of the aperture. For example, the offset may be the center of the aperture or a corner of the aperture. The delay aperture may include a characterization of the shape of the aperture (e.g., square, rectangle, circle, ellipse, hexagon, trapezoid, triangle, pentagon, octagon, decagon, or other shapes). The delay profile of the aperture may be further characterized by the minimum value, maximum value, and values of the delay used for computing the coefficients of the delay interpolation polynomial and the number of samples of the delay. The spatial and temporal relationship between the beam sent through the aperture and the signal received contains information about the structure of the target region.

Aperture 502 is circular, and an interpolation polynomial may be modeled based on a square circumscribing the circle. Aperture 504 straddles two dies, as indicated by the negative x-value. In some embodiments, the delay values for the aperture are computed on two different dies. Each die may choose a different origin to simplify the computation so that each die only needs to compute the delay values needed for that die. In some embodiments, each die computes the delay values used by both dies. In some embodiments, the delay values are computed, and then the delay values are sent to the dies that are in use. The computed values of the delay profile are loaded at the location in the array indicated by the information characterizing the aperture.

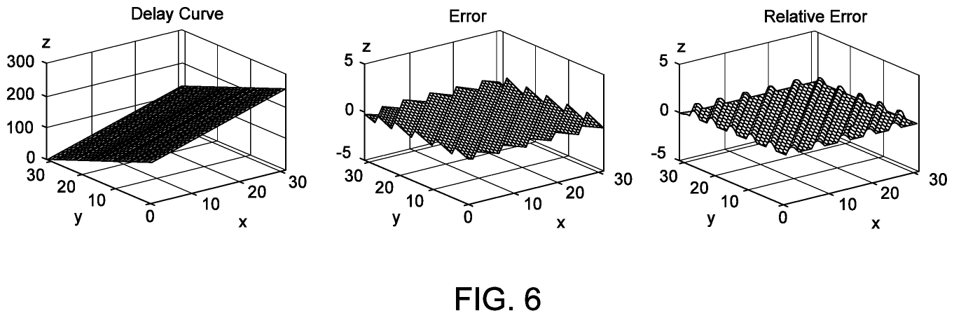

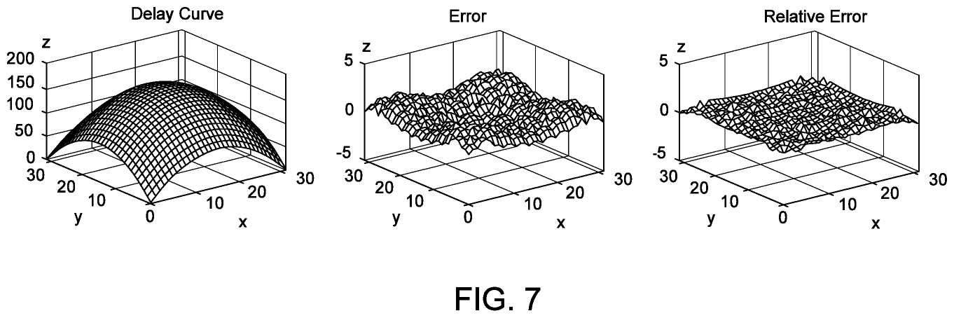

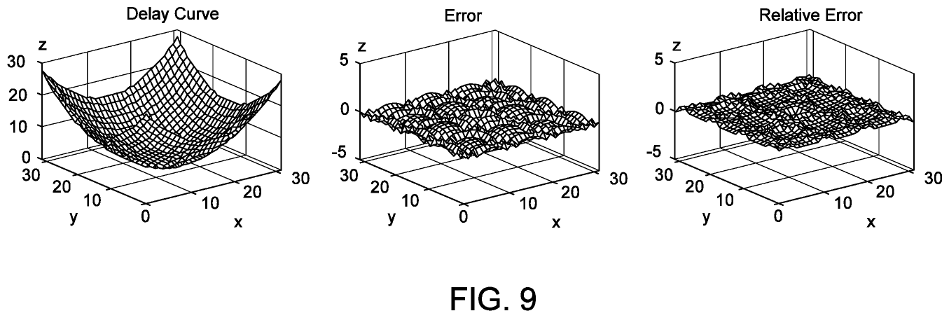

FIG. 6A illustrates an example of a delay profile. The delay profile of FIG. 6A may be used as an initial delay profile. The delay profile of FIG. 6A is a flat rectangle. In FIG. 6A, the plane wave is being steered to the right. FIG. 6B illustrates the error that results when using a delay profile computed by the method of FIG. 3. The errors in FIGS. 6B and 6C are due to the discretization. FIG. 6C illustrates the relative error in the delay profile computed by the method of FIG. 3. FIG. 7A illustrates another example of a delay profile, which may also be used as an initial delay profile. FIG. 7B illustrates the error in the delay profile computed by the method of FIG. 3. The error in FIG. 7B is due primarily to the curve that is being approximated is not bicubic. FIG. 7C illustrates the relative error in the delay profile computed by the method of FIG. 3. FIG. 8A illustrates another example of a delay profile that may be used as an initial delay profile. FIG. 8B illustrates the error in the delay profile computed by the method of FIG. 3. FIG. 8C illustrates the relative error in the delay profile computed by the method of FIG. 3. FIG. 9A illustrates another example of a delay profile that may be used as an initial delay profile. FIG. 9B illustrates the error in the delay profile computed by the method of FIG. 3. FIG. 9C illustrates the relative error in the delay profile computed by the method of FIG. 3. Other initial profiles may be used, according to the delay profile expected. As an example, the clock cycle may be 100 MHz, whereas the wave has a frequency of 10 MHz, so that the error is less than only a few clock cycles and less than a quarter wavelength. Although in that example, the clock cycles have a frequency that is 10 times the frequency of the desired wavelength, the chosen frequency may be between 5 and 15 times the frequency, or the ratio of the frequency of the clock to the desired wavelength may be a different ratio. In some embodiments, the clock cycle is kept above at least the Nyquist frequency (twice the frequency of the smallest wavelength of interest).

The initial delay profile may be used during an initial scan of a target region. Once more information about the target region is known, a more refined delay profile may be used during a subsequent scan.

The error illustrated in FIGS. 6B, 7B, 8B, and 9B is computed by comparing the interpolated delay file or estimated delay profile to the actual delay profile by subtracting the estimated or interpolated delay profile of FIGS. 6A, 7A, 8A, and 9A, from actual or desired delay profile, respectively. The relative error of FIGS. 6C, 7C, 8C, and 9C are computed by dividing the error of FIGS. 6B by 6A, 7B by 7A, 8B by 8A, and 9B by 9A, respectively.

The delay profile of FIG. 6A is an example of a plane wave. The delay profile of FIG. 7A is a diverging wave. The delay profile of FIG. 8A is a focused wave. The delay profile of FIG. 9A is a converging wave. The errors can be reduced, if needed, by dividing the region of the wave into multiple computational regions—each modeled by a different interpolation polynomial. In some embodiments, samples of the delay from the conical region are used to compute the delay function (for the focused wave).

In some embodiments, using a low-resolution profile of 16 delay values to derive coefficients of a bicubic polynomial, using the trapezoidal integration method, the total number of additions for updating the full array of 1 K transducers is 27,621. The size of the array leads to the following rough gate-estimates assuming 32-bit operations. A 10 μs time is budgeted for these calculations. This time period corresponds to 1000 clock cycles at 100 MHz or 500 clock cycles at 50 MHz.

### Waveform Reception

The particular transducer elements of the transducer array 102 that are coupled through the receive switch subsystem 106 define the aperture used by the system 100 for receiving that particular reflected signal. Each such transducer element forms a pixel that can be processed by the processor 119 in order to form an image to be displayed by the display 127. In some embodiments, the AFE 145 includes a Low Noise Amplifier (LNA) 145a, Variable Gain Amplifier (VGA) 145b, and Low Pass (LP) filter 145c. The AFE 145 receives imaging signals from the die 101, by the LNA 145a, to keep the noise low so that the analog signal received has a minimum of distortion. The VGA 145b receives input from FPGA 117 for how the gain should be varied. In some embodiments, by using the VGA 145b, the lower voltage components of the signal are de-emphasized, thereby de-emphasizing the noise. In some embodiments, the input from FPGA 117, helps ensure that the gain from VGA 145b is adjusted to emphasize the features that clarify the image and deemphasizing features that make the image less clear. After applying the LP filter 145c to the analog signal that was received, the analog signal is passed to the ADC 147, where the signal is digitized and then sent to the processor 119. At the processor 119, the analog signal and digitized signal are compared so as to correct errors in the digitized signal. The ADC 147 communicates with the FPGA 117 via the LVDSs or the SPI link. The processor 119 may store information, programs, or working memory in the Random Access Memory (RAM) 121 or the solid-state drive (SSD) 123. The processor 119 may communicate with other devices by ethernet 125.

Although the disclosed method and apparatus is described above in terms of various examples of embodiments and implementations, it should be understood that the particular features, aspects, and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a) an imaging array that generates an imaging signal;
b) a decompression subsystem that computes delays based on polynomial coefficients of a polynomial that computes the delays, the delays being delays between a signal sent by the imaging array; and
c) a pulser subsystem that computes a control signal, based on the polynomial coefficients, that causes the imaging array to send an imaging signal.

2. The system of claim 1, wherein the polynomial is bicubic.

3. The system of claim 1, wherein the polynomial is quadratic.

4. The system of claim 1, further comprising a switching subsystem that detects a signal received by the imaging array;

5. The system of claim 1, wherein the delays are computed by inserting position coordinates of an element of the imaging array into the polynomial, the delay being applied to the element.

6. The system of claim 1, wherein the delays are computed by interpolating the coefficients.

7. The system of claim 1, wherein the delays of a first group of elements are computed based on a second group of elements.

8. The system of claim 7, wherein elements of the first group are adjacent elements of the second group of elements.

9. The system of claim 7, wherein the delays of the first group of elements are computed by adding a first derivative of the delays to delays of the second group of elements.

10. The system of claim 9, wherein the first derivatives of the delays are computed by adding second derivatives of the delays to prior values of the first derivatives.

11. The system of claim 9, wherein derivatives of a first order of the delays are computed by adding derivatives of a second order of derivative of the delays to prior values of the first order of derivatives, the second-order being one degree higher than the first order.

12. The system of claim 11, wherein if a derivative of a particular order is a constant or zero, no higher derivatives of the derivative of the particular order are computed when computing the delays of the first group.

13. The system of claim 11, wherein the coefficients are computed from delay values of a group of elements that includes a smaller number of elements than are computed by the polynomial.

14. The system of claim 9, wherein elements of the first group are adjacent elements of the second group.

15. The system of claim 1, wherein the polynomial computes delays of a group of elements in which the delays vary at an amount that is less than a threshold value.

16. The system of claim 1, wherein the delays of a first row of elements are computed based at least in part on a second row of elements.

17. The system of claim 1, wherein the delays of a first column of elements are computed based on a second column of elements.

18. The system of claim 1, wherein the delays are computed from the polynomial coefficients by successively numerically integrating higher order derivatives of the polynomial to derive lower order derivatives of the polynomial until the delay value for a given point is arrived at by numerically integrating first-order derivative of the polynomial.

19. A method comprising:
a) generating, by an imaging array, an imaging signal;
b) computing, by a delay computation subsystem, delays based on polynomial coefficients of a polynomial that computes the delays, the delays being delays between signals sent by elements of the imaging array; and
c) computing, by a pulser subsystem, based on the polynomial, coefficients a control signal that causes the imaging array to send an imaging signal.

20. The method of claim 18, further comprising detecting, by a switching subsystem, a signal received by the imaging array.
